(19) United States
(12) Patent Application Publication
(10) Pub. No.: US 2005/0105561 A1
(43) Pub. Date: May 19, 2005

(54) Apparatus and method for automatically running multimedia data received in mobile communication terminal

(75) Inventor: Hyun Soo Kim, Seongnam-Si (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: CURITEL COMMUNICATIONS, INC.

(21) Appl. No.: 10/987,459

(22) Filed: Nov. 12, 2004

(30) Foreign Application Priority Data
Nov. 14, 2003 (KR) 10-2003-0080510

(51) Int. Cl. H04J 3/06; H04J 3/24; H04B 7/00

(52) U.S. Cl. 370/503; 370/310

(57) ABSTRACT

Disclosed are an apparatus and a method for automatically running multimedia data received in a mobile communication terminal. The apparatus comprises: a Multimedia Message Service (MMS) message generating unit for generating MMS message, setting up run time, at which multimedia data or application included in the MMS message is run; an MMS message transceiver unit for transmitting the MMS message to a first MMS client and receiving MMS message from a second MMS client; an MMS message analyzing unit for analyzing the MMS message and for setting up run time for the multimedia data or application according to the run time set up in the MMS message, if the run time for the multimedia data or application is set up in the MMS message; and a multimedia data/application running unit for automatically running the multimedia data or application when it comes the run time set up by the MMS message analyzing unit.

### CROSS-REFERENCE TO RELATED APPLICATION

The entire disclosure of Korean Patent Application No. 10-2003-0080510 filed on Nov. 14, 2003 including specification, claims, drawings and summary, is incorporated herein by reference in its entirety.

### BACKGROUND OF THE INVENTION

1. Field of the Invention

The present invention relates to an apparatus and a method for automatically running multimedia data received in a mobile communication terminal, and more particularly to an apparatus and a method for automatically running multimedia data received in a mobile communication terminal, making it possible to automatically run multimedia data or an application received through a multimedia messaging service.

2. Background of the Related Art

Generally, a multimedia message service (MMS) is a next-generation message service exchanging a large quantity of messages including multimedia such as a text, a music file and a moving picture file, etc., using a wireless internet based mobile communication terminal, contrary to an existing short message service (SMS) transmitting a simple text message.

As described above, mobile communication subscribers can transmit and receive various formats of multimedia message using the MMS. The mobile communication terminal, which received a multimedia message through the MMS, informs the subscriber of a message reception through, for example, a buzzer sound and the mobile communication subscriber, who perceived the message reception, runs the received message through a key operation.

Like above, the prior MMS has a problem in that the MMS just transmits a message including multimedia data such as a music file and a moving picture image, etc. to a mobile communication subscriber.

### SUMMARY OF THE INVENTION

Accordingly, the present invention has been made to solve the above-mentioned problems occurring in the related art. The object of the present invention is to provide an apparatus and a method for automatically running multimedia data received in a mobile communication terminal, which sets up and adds a run time to a header part of an MMS message and thus makes it possible for a mobile communication terminal to automatically run multimedia data or an application included in the MMS message at the set run time.

In order to accomplish the object, there is provided an apparatus for automatically running multimedia data received in a mobile communication terminal comprising: a Multimedia Message Service (MMS) message generating unit for generating MMS message, setting up run time, at which multimedia data or application included in the MMS message is run, in a header part of the MMS message; and an MMS message transmitting unit for transmitting the MMS message generated in the MMS message generating unit to a first MMS client.

Preferably, the apparatus for automatically running multimedia data received in a mobile communication terminal may further comprise: an MMS message receiving unit for receiving MMS message from a second MMS client; an MMS message analyzing unit for making a multimedia data/application storage unit store the multimedia data or application included in the MMS message received through the MMS receiving unit, for analyzing the header part of the MMS message, and for setting up run time for the multimedia data or application according to the run time set up in the header part of the MMS message, if the run time for the multimedia data or application is set up in the header part of the MMS message; and a multimedia data/application running unit for automatically running the multimedia data or application stored in the multimedia data/application storage unit when it comes the run time set up by the MMS message analyzing unit.

Preferably, the MMS message may comprise: a data part for recording the multimedia data or application therein; and a header part for setting up therein at least one of a message type, a message size, caller information, recipient information and a run time, at which the multimedia data or application recorded in the data part is run.

Preferably, the multimedia data may comprise at least one of a text, a music file and a moving picture image.

Preferably, the application may be at least one of a group consisting of a call set-up application and a location track application.

Alternatively, there is provided another apparatus for automatically running multimedia data received in a mobile communication terminal comprising: a Multimedia Message Service (MMS) message generating unit for generating MMS message, setting up run time, at which multimedia data or application included in the MMS message is run, in a header part of the MMS message; an MMS message transceiver unit for transmitting the MMS message generated in the MMS message generating unit to a first MMS client and receiving MMS message from a second MMS client; an MMS message analyzing unit for making a multimedia data/application storage unit store the multimedia data or application included in the MMS message received through the MMS transceiver unit, for analyzing the header part of the MMS message, and for setting up run time for the multimedia data or application according to the run time set up in the header part of the MMS message, if the run time for the multimedia data or application is set up in the header part of the MMS message; and a multimedia data/application running unit for automatically running the multimedia data or application stored in the multimedia data/application storage unit when it comes the run time set up by the MMS message analyzing unit.

Preferably, the MMS message may comprise: a data part for recording the multimedia data or application therein; and a header part for setting up therein at least one of a message type, a message size, caller information, recipient information and a run time, at which the multimedia data or application recorded in the data part is run.

Preferably, the multimedia data may comprise at least one of a text, a music file and a moving picture image.

Preferably, the application may be at least one of a group consisting of a call set-up application and a location track application.

Alternatively, there is provided a method for automatically running multimedia data received in a mobile communication terminal comprising acts of: generating at transmitting side Multimedia Message Service (MMS) client an MMS message having information on a run time for multimedia data or application included in the MMS message and transmitting the MMS message to receiving side MMS client; and analyzing the MMS message at the receiving side MMS client, and running the multimedia data or application included in the MMS message at the receiving side MMS client if the run time for the multimedia data or application is set up in the MMS message.

Preferably, the act of generating and transmitting the MMS message may comprise: generating the MMS message, with setting up run time, at which the multimedia data or application included in the MMS message is run, in a header part of the MMS message; and transmitting the MMS message to the receiving side MMS client.

Preferably, the act of analyzing and running the MMS message may comprise: analyzing a header part of the MMS message at the receiving side MMS client and judging whether the run time is set up or not; if the run time is set up, setting up a run time at which the multimedia data or application included in the MMS message is run, based on the run time originally set up in the header part of the MMS message; and automatically running the multimedia data or application included in the MMS message when it comes the run time set up at the receiving side MMS client.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a structure of an MMS system to which a preferred embodiment of the present invention is applied;

FIG. 2 illustrates a structure of an MMS message applied to a preferred embodiment of the present invention;

FIG. 3 is an exemplary view illustrating a structure of an apparatus for automatically running multimedia data received in a mobile communication terminal according to a preferred embodiment of the present invention; and

FIG. 4 is a flow chart for illustrating a method for automatically running multimedia data received in a mobile communication terminal according to a preferred embodiment of the present invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

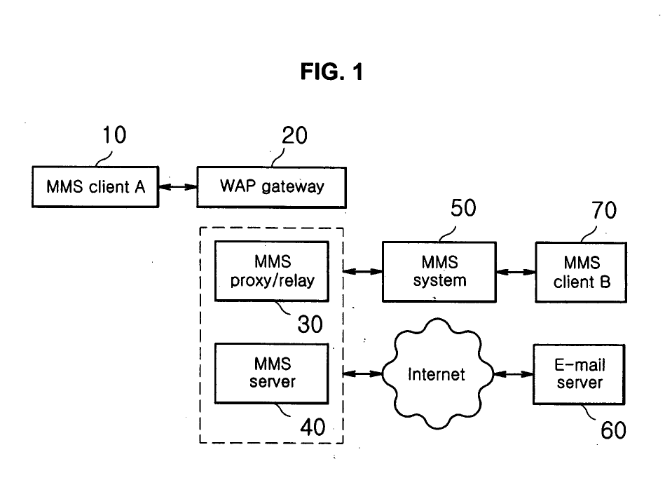

FIG. 1 illustrates a structure of an MMS system to which a preferred embodiment of the present invention is applied, which comprises MMS clients 10, 70, a wireless application protocol (WAP) gateway 20, an MMS proxy/relay 30, an MMS server 40, an MMS system 50 and an e-mail server 60.

With such a construction, a transmitting side MMS client, such as the MMS client A 10, generates an MMS message, initialize a WAP session and transmits the MMS message to a receiving side MMS client, such as the MMS client B 70, via a wireless session protocol/hypertext transfer protocol (WSP/HTTP). The receiving side MMS client then analyzes the MMS message received from the transmitting side MMS client. When generating the MMS message at the transmitting side MMS client, the transmitting side MMS client sets up a run time at which multimedia data or an application included in the multimedia message is run.

The WAP gateway 20 is provided to the MMS proxy/relay 30, and transmits the multimedia message to the receiving side MMS client, interworking with a web server (not shown) for transmitting the MMS message to the receiving side MMS client.

The MMS proxy/relay 30 interworks with an internet protocol (IP) network, processes the multimedia message received from the transmitting side MMS client by retrieving a receiver's profile, and executes functions of checking the present states of messages or sources and system statistics to process the multimedia message.

The MMS server 40 stores and manages the multimedia message.

The MMS system 50 provides a wireless multimedia message service through a corresponding MMS mode.

The e-mail server 60 receives the multimedia message, interworking with the transmitting side MMS client such as a PC, via an Internet.

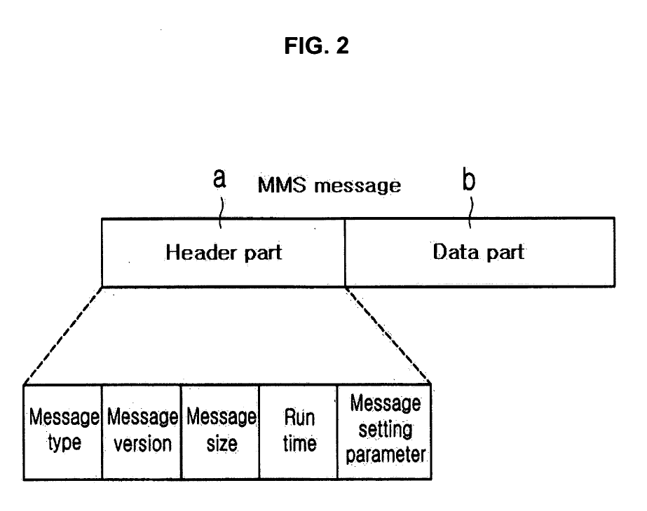

FIG. 2 illustrates a structure of an MMS message applied to a preferred embodiment of the present invention. The MMS message comprises an MMS message header part (a) where information on a message type, a message version, a message size and a run time (year/month/day/hour/minute/second), caller information and recipient information are set up, and an MMS message data part (b) where multimedia data or an application are recorded.

The length, contents and orders of the MMS message header part (a) are variable and different according to a service supported. The MMS message header part (a) further comprises header information having a structure as following and supports a function of setting up the run time.

Struct tag_mms_runtime_stamp

{
unsigned int year//Year 4-digit. 0000-9999 binary
   unsigned int month//Month 2-digit 1-12 binary
   unsigned int day//Day 2-digit 1-31 binary
   unsigned int hour//Hour 2-digit 0-23 binary
   unsigned int min//Min 2-digit 0-59 binary
   unsigned int sec//Second 2-digit 0-59 binary
   };

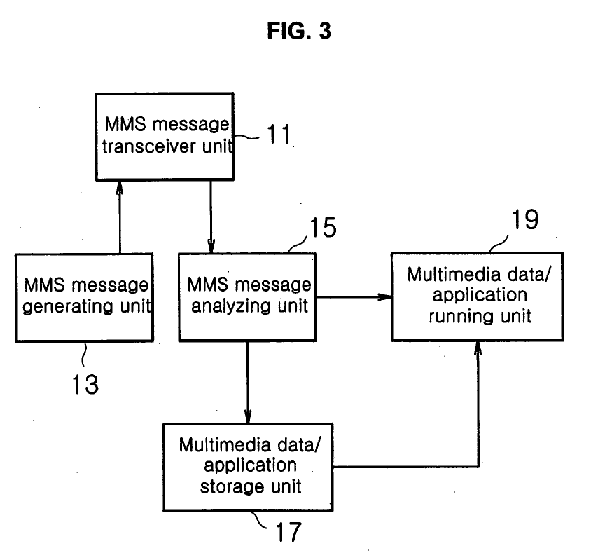

FIG. 3 is an exemplary view illustrating a structure of an apparatus for automatically running multimedia data received in a mobile communication terminal according to a preferred embodiment of the present invention. The apparatus comprises an MMS message transceiver unit 11, an MMS message generating unit 13, an MMS message analyzing unit 15, a multimedia data/application storage unit 17 and a multimedia data/application running unit 19.

With such a construction, the MMS message transceiver unit 11 transmits an MMS message generated in the MMS message generating unit 13 to a receiving side MMS client via a WSP/HTTP and receives MMS message from a transmitting side MMS client.

The MMS message generating unit 13 generates an MMS message to be transmitted to the receiving side MMS client. At this time, the MMS message generating unit 13 sets up a run time, at which multimedia data or an application included in the MMS message is automatically run at the receiving side MMS client, in the MMS message header part (a). The MMS message generating unit 13 then transmits the generated MMS message to the receiving side MMS client by transmitting the MMS message to the MMS message transceiver unit 11 of the receiving side MMS client.

The MMS message analyzing unit 15 makes the multimedia data/application storage unit 17 store the multimedia data or application included in the data part of the MMS message received through the MMS message transceiver unit 11, analyzes the header part (a) of the MMS message and thus judges whether the run time, at which the multimedia data or the application included in the data part (b) of the MMS message is run, is set up or not. If the run time is set up, the MMS message analyzing unit sets up a time at which the multimedia data or application is automatically run.

The multimedia data/application storage unit 17 stores the multimedia data or application received through the MMS message analyzing unit 15.

The multimedia data/application running unit 19 runs the multimedia data or the application stored in the multimedia data/application storage unit 17 when it comes the time set up by the MMS message analyzing unit 15.

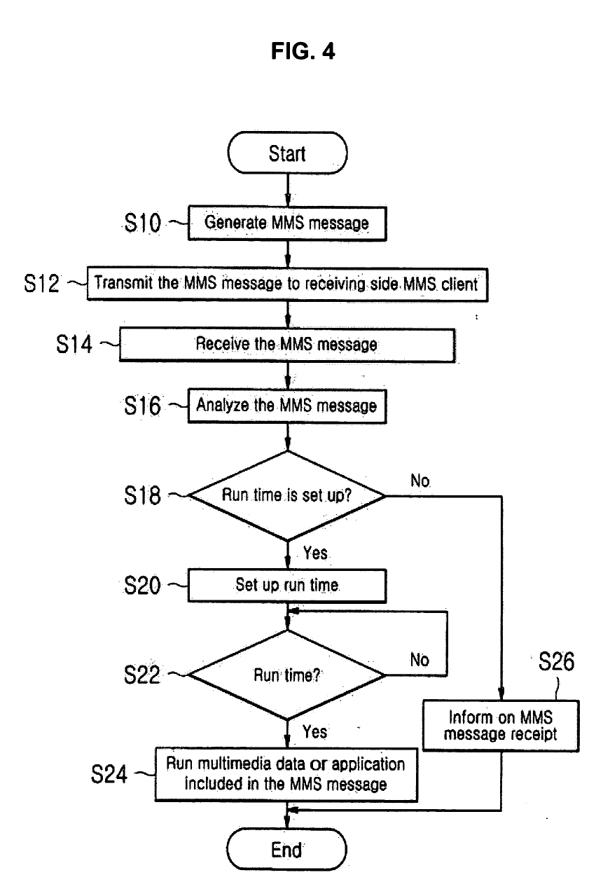

FIG. 4 is a flowchart for illustrating a method for automatically running multimedia data received in a mobile communication terminal according to a preferred embodiment of the present invention.

Firstly, an MMS message, which is transmitted to the receiving side MMS client from the transmitting side MMS client, is generated (S10).

When generating the MMS message, a run time, at which the multimedia data or the application included in the MMS message is automatically played or run at the receiving side MMS client after receiving the MMS message, is set up.

Then, a WAP session is initialized and the MMS message is transmitted to the receiving side MMS client via a WSP/HTTP. At this time, the transmitting side MMS client transmits the MMS message to the receiving side MMS client using a WAP Push (S12).

Meanwhile, after initializing the WAP session, the receiving side MMS client, which received the MMS message, analyzes a header part of the MMS message and thus judges whether the run time is set up or not (S14, S16, S18).

As a result of the judgment in the step S18, if the run time is set up, a time for automatically running the multimedia data or application included in the MMS message is set up using an alarm function, based on the run time set up in the header part of the MMS message (S20).

When setting up the run time using the alarm function in the step S20, the run time is set up with information on the MMS message to distinguish the run time from the existing alarm time.

Then, it is judged whether or not it comes the run time set up in the step S20 (S22).

As a result of the judgment in the step S22, when it comes the run time, the multimedia data or application included in the MMS message is played or run (S24).

Meanwhile, as a result of the judgment in the step S18, if the run time is not set up, a message reception is informed to a subscriber through a buzzer sound as the prior art and the received MMS message is stored in a memory unit (S26).

The subscriber, who perceived the message reception through the step S26, runs the received message through a key operation.

Hereinafter, a method for automatically running multimedia data received in a mobile communication terminal according to a preferred embodiment of the present invention will be described with reference to FIGS. 1 to 4.

When a transmitting side MMS client transmits an MMS message including a music file to a receiving side MMS client, the transmitting side MMS client generates the MMS message, setting up a time at which the music file included in the MMS message is run, for example, 10:30:00, Sep. 30, 2003.

After that, the transmitting side MMS client transmits the MMS message to the receiving side MMS client via a WAP gateway 20.

As described above, the MMS message, which is transmitted by the transmitting side MMS client, is delivered to the receiving side MMS client via an MMS proxy/relay 30 and an MMS system 50, etc. The receiving side MMS client, which received the MMS message, analyzes a header part (a) of the received MMS message. If a time, at which the music file included in the MMS message is run, is set up, the receiving side MMS client sets up a time (10:30:00, Sep. 30, 2003), at which the music file is run, with an alarm function, based on the run time set up in the header part (a) of the MMS message.

After that, when it comes the run time (10:30:00, Sep. 30, 2003) set with the alarm function, the receiving side MMS client automatically plays the music file included in the MMS message.

Meanwhile, when the transmitting side MMS client transmits an MMS message including an application related to a call/location track to the receiving side MMS client, the transmitting side MMS client generates the MMS message, setting up a time at which the application included in the MMS message is run (for example, instant running).

After that, the transmitting side MMS client transmits the MMS message to the receiving side MMS client via the WAP gateway 20.

As described above, the MMS message, which is transmitted by the transmitting side MMS client, is delivered to the receiving side MMS client via the MMS proxy/relay 30 and the MMS system 50, etc. The receiving side MMS client, which received the MMS message, analyzes a header part (a) of the received MMS message. If a time, at which the application included in the MMS message is run, is set up(for example, instant running), the receiving side MMS client immediately runs the application included in the MMS message, based on the time set up in the MMS message.

At this time, when the application included in the MMS message is a call set-up application, the receiving side MMS client automatically runs a call set-up with the transmitting side MMS client. When the application included in the MMS message is a location track application, the receiving side MMS client identifies its current location and informs the transmitting side MMS client of the current location.

As described above, according to the present invention, a run time is added to a header part of an MMS message. Accordingly, a mobile communication terminal, which received the MMS message, automatically runs the multimedia data or application included in the MMS message on the set run time and thus more diverse functions and services can be provided.

While the present invention has been shown and described with reference to certain preferred embodiments thereof, it will be understood by those skilled in the art that various changes in form and details may be made therein without departing from the spirit and scope of the invention as defined by the appended claims.

1. Apparatus for automatically running multimedia data received in a mobile communication terminal comprising:
a Multimedia Message Service (MMS) message generating unit for generating MMS message, setting up run time, at which multimedia data or application included in the MMS message is run, in a header part of the MMS message; and
an MMS message transmitting unit for transmitting the MMS message generated in the MMS message generating unit to a first MMS client.

2. The apparatus according to claim 1, further comprising:
an MMS message receiving unit for receiving MMS message from a second MMS client;
an MMS message analyzing unit for making a multimedia data/application storage unit store the multimedia data or application included in the MMS message received through the MMS receiving unit, for analyzing the header part of the MMS message, and for setting up run time for the multimedia data or application according to the run time set up in the header part of the MMS message, if the run time for the multimedia data or application is set up in the header part of the MMS message; and
a multimedia data/application running unit for automatically running the multimedia data or application stored in the multimedia data/application storage unit when it comes the run time set up by the MMS message analyzing unit.

3. The apparatus according to claim 1, wherein the MMS message comprises:
a data part for recording the multimedia data or application therein; and
a header part for setting up therein at least one of a message type, a message size, caller information, recipient information and a run time, at which the multimedia data or application recorded in the data part is run.

4. The apparatus according to claim 1, wherein the multimedia data comprises at least one of a text, a music file and a moving picture image.

5. The apparatus according to claim 1, wherein the application is at least one of a group consisting of a call set-up application and a location track application.

6. The apparatus according to claim 2, wherein the MMS message comprises:
a data part for recording the multimedia data or application therein; and
a header part for setting up therein at least one of a message type, a message size, caller information, recipient information and a run time, at which the multimedia data or application recorded in the data part is run.

7. The apparatus according to claim 2, wherein the multimedia data comprises at least one of a text, a music file and a moving picture image.

8. The apparatus according to claim 2, wherein the application is at least one of a group consisting of a call set-up application and a location track application.

9. An apparatus for automatically running multimedia data received in a mobile communication terminal comprising:
a Multimedia Message Service (MMS) message generating unit for generating MMS message, setting up run time, at which multimedia data or application included in the MMS message is run, in a header part of the MMS message;
an MMS message transceiver unit for transmitting the MMS message generated in the MMS message generating unit to a first MMS client and receiving MMS message from a second MMS client;
an MMS message analyzing unit for making a multimedia data/application storage unit store the multimedia data or application included in the MMS message received through the MMS transceiver unit, for analyzing the header part of the MMS message, and for setting up run time for the multimedia data or application according to the run time set up in the header part of the MMS message, if the run time for the multimedia data or application is set up in the header part of the MMS message; and
a multimedia data/application running unit for automatically running the multimedia data or application stored in the multimedia data/application storage unit when it comes the run time set up by the MMS message analyzing unit.

10. The apparatus according to claim 9, the MMS message comprises:
a data part for recording the multimedia data or application therein; and
a header part for setting up therein at least one of a message type, a message size, caller information, recipient information and a run time, at which the multimedia data or application recorded in the data part is run.

11. The apparatus according to claim 9, wherein the multimedia data comprises at least one of a text, a music file and a moving picture image.

12. The apparatus according to claim 9, wherein the application is at least one of a group consisting of a call set-up application and a location track application.

13. A method for automatically running multimedia data received in a mobile communication terminal comprising acts of:
generating at transmitting side Multimedia Message Service (MMS) client an MMS message having information on a run time for multimedia data or application included in the MMS message and transmitting the MMS message to receiving side MMS client; and
analyzing the MMS message at the receiving side MMS client, and running the multimedia data or application included in the MMS message at the receiving side MMS client if the run time for the multimedia data or application is set up in the MMS message.

14. The method according to claim 13, wherein the act of generating and transmitting the MMS message comprises:
generating the MMS message, with setting up run time, at which the multimedia data or application included in the MMS message is run, in a header part of the MMS message; and
transmitting the MMS message to the receiving side MMS client.

15. The method according to claim 13, wherein the act of analyzing and running the MMS message comprises:
analyzing a header part of the MMS message at the receiving side MMS client and judging whether the run time is set up or not;
if the run time is set up, setting up a run time at which the multimedia data or application included in the MMS message is run, based on the run time originally set up in the header part of the MMS message; and
automatically running the multimedia data or application included in the MMS message when it comes the run time set up at the receiving side MMS client.
